(19) United States
(12) Patent Application Publication
(10) Pub. No.: US 2026/0300968 A1
(43) Pub. Date: Oct. 1, 2026

(54) BLOCK GENERATING METHOD

(71) Applicant: YCONS CO.,LTD, Seoul (KR)

(72) Inventors: Seungil KIM, Seoul (KR); Yongwoon KIM, Seoul (KR)

(21) Appl. No.: 19/688,528

(22) Filed: May 27, 2026

Related U.S. Application Data
(63) Continuation of application No. PCT/KR2024/017459, filed on Nov. 7, 2024.

(30) Foreign Application Priority Data
Dec. 12, 2023 (KR) 10-2023-0179714

(51) Int. Cl. G06Q 20/38

(52) U.S. Cl. CPC G06Q 20/389

(57) ABSTRACT

According to several embodiments of the present disclosure, a block generation method performed by a computing device including at least one processor is disclosed. The block generation method may include: obtaining a first transaction from a node in which a transaction included in a blockchain network has occurred; and when the first transaction is obtained, generating a first block for recording the first transaction based on whether any one of preset conditions is satisfied. The preset conditions may include: a first condition that is satisfied when receiving the first transaction causes the number of transactions not recorded in a block to reach a preset number; and a second condition that is satisfied when an acquisition time of a second transaction acquired earliest among the transactions not recorded in a block reaches a preset time.

### CROSS-REFERENCE TO RELATED APPLICATION

This application is a U.S. Bypass Continuation Application of International Application No. PCT/KR2024/017459, filed on Nov. 11, 2024, which claims priority to and the benefit of Korean Patent Application No. 10-2023-0179714, filed on Dec. 12, 2023, the disclosure of which is incorporated herein by reference in its entirety.

### BACKGROUND

### Technical Field

The present disclosure relates to a block generation method and, more particularly, to a method of generating a block constituting a blockchain network.

### Background Art

Recently, blockchain technology has been used in new innovative technologies such as Web 3.0 technology, NFTs, or the Metaverse. In particular, with the emergence of NFT (Non-Fungible Token) technology, people worldwide have become able to convert various assets into NFTs and partially own the assets. Alternatively, people can share and use assets together, and can also tokenize and trade the assets as easily as a single item.

In addition, NFT transactions for trading only ownership, as well as transactions involving physical goods, have become possible. As such social and economic activities are also extended to a virtual world called the metaverse, the applicability thereof is further increasing.

However, in the early stages of the NFT market, NFT prices sharply increased due to speculative enthusiasm and numerous NFT marketplaces increased, thereby causing a problem in which unverified NFTs proliferated. Such NFTs have exhibited problems such as complicated processes from creation and storage to transaction, and high fees.

### SUMMARY

The present disclosure has been devised in response to the above-described background art, and is intended to provide a block generation method in which unnecessary resources are not generated.

The technical problems of the present disclosure are not limited to the technical problem described above, and other technical problems not mentioned herein will be clearly understood by those skilled in the art from the following description.

According to an embodiment of the present disclosure for solving the problems described above, a block generation method performed by a computing device including at least one processor is disclosed. The block generation method may include: obtaining a first transaction from a node in which a transaction included in a blockchain network has occurred; and when the first transaction is obtained, generating a first block for recording the first transaction based on whether any one of preset conditions is satisfied. The preset conditions may include: a first condition that is satisfied when receiving the first transaction causes the number of transactions not recorded in a block to reach a preset number; and a second condition that is satisfied when an acquisition time of a second transaction acquired earliest among the transactions not recorded in a block reaches a preset time.

In addition, the block generation method may further include: when the first block is generated, determining whether at least one second block corresponding to the first block exists; when the at least one second block exists, determining a sum of the number of the first block and the at least one second block; when the sum of the number reaches a preset number, determining a first hash value using the first block and the at least one second block; and generating a third block using the first hash value.

In addition, the step of, when the sum of the number reaches the preset number, determining the first hash value using the first block and the at least one second block may include: extracting a first block seed value from a seed value for the first block according to a preset rule; extracting at least one second block seed value from a seed value for each of the at least one second block according to a preset rule; generating an integrated seed value by connecting the first block seed value and the at least one second block seed value in chronological order representing a connection relationship between respective blocks; and determining the first hash value through a hash function using the integrated seed value as an input.

In addition, the step of, when the first transaction is obtained, generating a first block for recording the first transaction based on whether any one of preset conditions is satisfied may include: determining whether the first condition is satisfied; when the first condition is satisfied, generating the first block; when the first condition is not satisfied, determining whether the second condition is satisfied; and when the second condition is satisfied, generating the first block.

In addition, the block generation method may further include determining at least one hash rate for determining a reward according to generation of the first block. The at least one hash rate may include at least one of: a volume hash rate related to a quantity staked in a plurality of nodes included in the blockchain network; an additional hash rate that is satisfied when the quantity exceeds a preset condition; and a time hash rate related to a time for which staking has been performed in the plurality of nodes included in the blockchain network.

The technical solutions obtainable from the present disclosure are not limited to the solutions described above, and other solutions not mentioned herein will be clearly understood by those skilled in the art from the following description.

According to several embodiments of the present disclosure, it is possible to provide a block generation method in which waste of resources does not occur.

The effects obtainable from the present disclosure are not limited to the effects described above, and other effects not mentioned herein will be clearly understood by those skilled in the art from the following description.

### BRIEF DESCRIPTION OF THE DRAWINGS

Various aspects will now be described with reference to the drawings, wherein like reference numerals are used throughout to refer to like elements. In the following embodiments, for purposes of explanation, numerous specific details are set forth in order to provide a thorough understanding of one or more aspects. It will be apparent, however, that such aspect(s) may be practiced without these specific details. In other instances, well-known structures and devices are shown in block diagram form in order to facilitate describing one or more aspects.

FIG. 1 illustrates an exemplary system for performing a block generation method according to several embodiments of the present disclosure.

FIG. 2 is a diagram for describing an example of a method by which a computing device generates a block according to several embodiments of the present disclosure.

FIG. 3 is a flowchart for describing an example of a method by which a computing device determines whether preset conditions are satisfied according to several embodiments of the present disclosure.

FIG. 4 is a flowchart for describing an example of a method by which a computing device compresses blocks according to several embodiments of the present disclosure.

FIG. 5 is a flowchart for describing an example of a method by which a computing device determines a first hash value according to several embodiments of the present disclosure.

### DETAILED DESCRIPTION

The present invention may be variously modified and may have various embodiments, and particular embodiments are illustrated in the drawings and will be described in detail in the detailed description. However, this is not intended to limit the present invention to particular embodiments, and should be understood to include all modifications, equivalents, and substitutions included in the spirit and technical scope of the present invention. In describing the drawings, like reference numerals are used for like elements.

Terms such as first, second, A, and B may be used to describe various components, but the components should not be limited by the terms. The terms are used only for the purpose of distinguishing one component from another component. For example, without departing from the scope of the present invention, a first component may be referred to as a second component, and similarly, a second component may be referred to as a first component. The term and/or includes a combination of a plurality of related listed items or any one of the plurality of related listed items.

When a component is referred to as being “connected” or “coupled” to another component, it should be understood that the component may be directly connected or coupled to the other component, or that another component may be interposed therebetween. In contrast, when a component is referred to as being “directly connected” or “directly coupled” to another component, it should be understood that no other component is interposed therebetween.

The terms used in the present application are used only to describe particular embodiments and are not intended to limit the present invention. Singular expressions include plural expressions unless the context clearly indicates otherwise. In the present application, terms such as “comprise” or “have” are intended to specify the presence of features, numbers, steps, operations, components, parts, or combinations thereof described in the specification, and should not be understood as precluding in advance the presence or addition of one or more other features, numbers, steps, operations, components, parts, or combinations thereof.

Unless otherwise defined, all terms used herein, including technical or scientific terms, have the same meanings as those generally understood by those skilled in the art to which the present invention pertains. Terms such as those defined in generally used dictionaries should be interpreted as having meanings consistent with their meanings in the context of the relevant art, and should not be interpreted in an idealized or excessively formal sense unless expressly defined in the present application.

In the present disclosure, a computing device may receive a transaction from a node included in a blockchain network. The computing device may determine whether to generate a block based on the received transaction. Conventionally, whenever a transaction is received, a computing device generates a block and verifies the integrity of the transaction. However, as the computing device generates a block each time, problems have occurred, such as unnecessary fees, a decrease in the speed of a transaction process, or a decrease in the speed of proving integrity. In contrast, when a transaction is received, the computing device according to the present disclosure may generate a block based on whether preset conditions are satisfied. Accordingly, generation of unnecessary resources may be prevented.

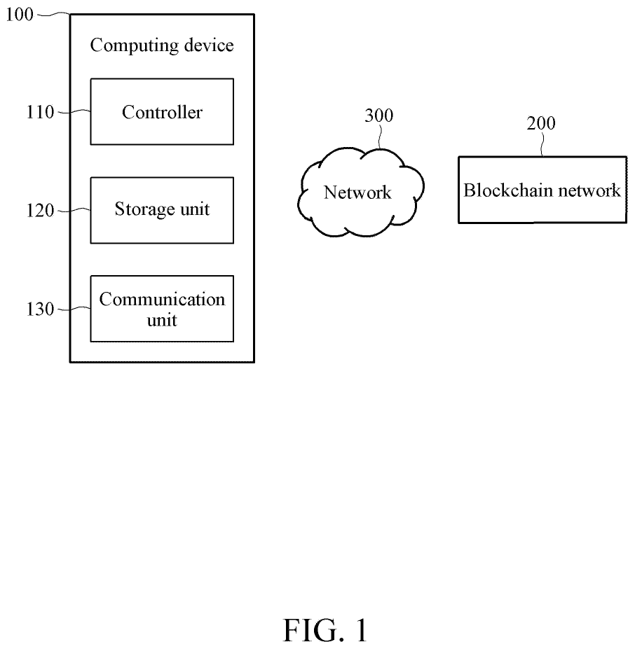

Hereinafter, a block generation method according to the present disclosure will be described with reference to FIGS. 1 to 5.

FIG. 1 illustrates an exemplary system for performing a block generation method according to several embodiments of the present disclosure.

Referring to FIG. 1, the computing device (100) may include a controller (110), a storage unit (120), and a communication unit (130). However, the above-described components are not essential for implementing the computing device (100), and the computing device (100) may have more or fewer components than those listed above.

The computing device (100) may include any type of computer system or computer device, such as, for example, a microprocessor, a mainframe computer, a digital processor, a portable device, or a device controller.

The computing device (100) may achieve desired system performance using a combination of typical computer hardware (for example, an apparatus that may include a computer processor, memory, storage, an input device and an output device, and other components of an existing computing device; an electronic communication device such as a router or a switch; and an electronic information storage system such as network-attached storage (NAS) and a storage area network (SAN)) and computer software (that is, instructions that cause a computing device to function in a particular manner).

In the present disclosure, the computing device may be a master node or a server node connected to the blockchain network (200). Alternatively, the computing device may be a master node that is one of the nodes constituting the blockchain network (200). A node having performance equal to or higher than a certain level for performing functions of a blockchain may be determined as the computing device.

The controller (110) may generally process overall operations of the computing device (100). The controller (110) may provide or process appropriate information or functions to a user by processing signals, data, information, or the like input or output through components of the computing device (100), or by executing an application program stored in the storage unit (120).

The controller (110) may include one or more cores, and may include a processor for data analysis, such as a central processing unit (CPU), a general purpose graphics processing unit (GPGPU), or a tensor processing unit (TPU).

In the present disclosure, when a transaction is obtained from at least one node included in the blockchain network (200), the controller (110) may determine whether any one of preset conditions is satisfied. For example, the controller (110) may determine whether the number of transactions not recorded in a block reaches a preset number.

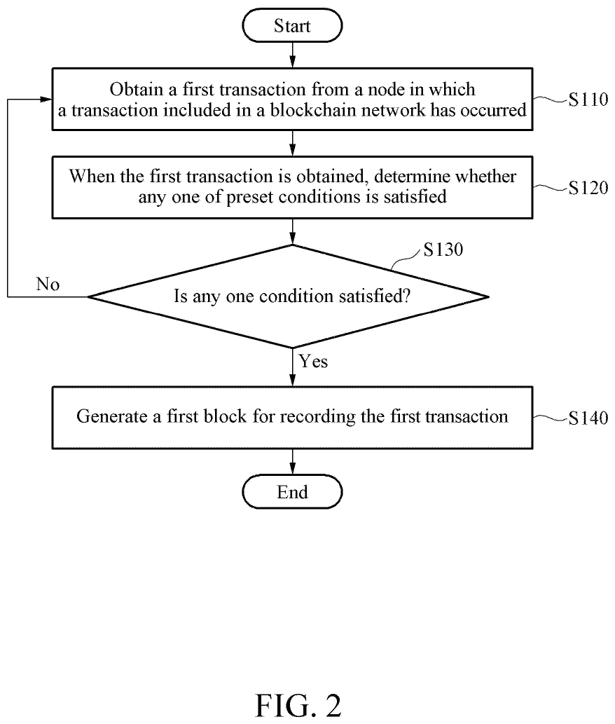

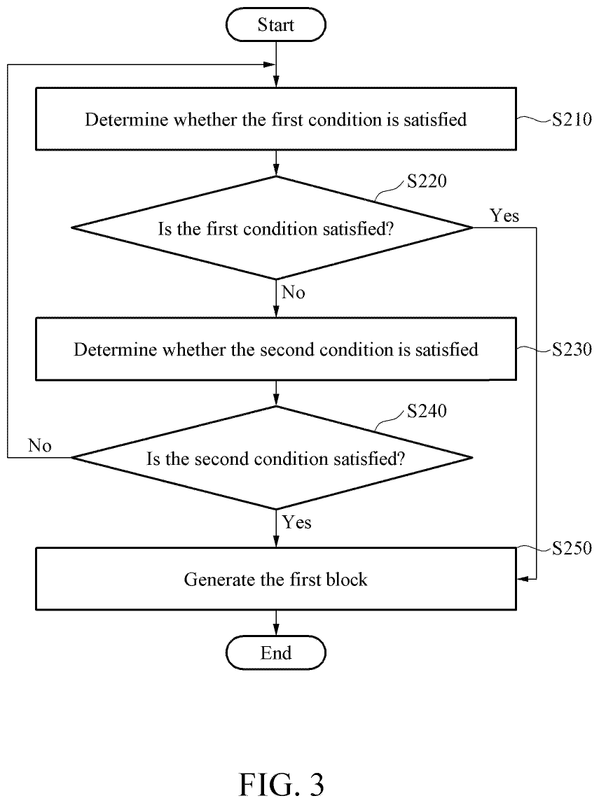

Alternatively, the controller (110) may determine whether an acquisition time of a transaction acquired earliest among the transactions not recorded in a block has reached a preset time. When any one condition is satisfied, the controller (110) may generate a block for recording the transaction obtained from the at least one node. Accordingly, unnecessary waste of resources may be prevented. Hereinafter, an example of a method by which the controller (110) generates a block for recording a transaction will be described with reference to FIGS. 2 and 3.

The storage unit (120) may include memory and/or a permanent storage medium. The memory may include at least one type of storage medium among a flash memory type, a hard disk type, a multimedia card micro type, a card-type memory (for example, SD or XD memory), random access memory (RAM), static random access memory (SRAM), read-only memory (ROM), electrically erasable programmable read-only memory (EEPROM), programmable read-only memory (PROM), magnetic memory, a magnetic disk, and an optical disk. The storage unit (120) may store transactions not recorded in a block.

The communication unit (130) may include one or more modules that enable communication between the computing device (100) and a communication system, between the computing device (100) and the blockchain network (200), or between the computing device (100) and the network (300).

The blockchain network (200) may be a network for launching and operating a blockchain project. The blockchain network (200) may include an unspecified number of nodes, and may record transactions and verify the transactions according to a blockchain protocol. The blockchain network (200) may issue tokens according to a predetermined protocol and record and verify transactions relating to ownership of the tokens. Although one blockchain network (200) is illustrated in FIG. 1 for convenience, the embodiment is not limited thereto. The computing device (100) may communicate with a plurality of different types of blockchain networks (200). Each blockchain network (200) may be operated according to a blockchain protocol supporting NFTs. Examples of a blockchain protocol supporting NFTs include Ethereum, WAX, FLOW, and Binance Smart Chain, but the embodiment is not limited thereto. An NFT may be issued according to the above-described protocols such as Ethereum, WAX, FLOW, and Binance Smart Chain. The issuance amount of the NFT may be limited. For example, the issuance amount of the NFT may be 1. However, the embodiment is not limited thereto. The issuance amount of the NFT may be a number greater than 1. The issuance amount of the NFT may be significantly smaller than the issuance amount of a fungible token.

The network (300) may be a closed network such as a local area network (LAN) or a wide area network (WAN), or an open network such as the Internet. The Internet refers to a worldwide open computer network structure that provides the TCP/IP protocol and various services existing in higher layers thereof, such as Hyper Text Transfer Protocol (HTTP), Telnet, File Transfer Protocol (FTP), Domain Name System (DNS), Simple Mail Transfer Protocol (SMTP), Simple Network Management Protocol (SNMP), Network File Service (NFS), and Network Information Service (NIS).

Hereinafter, a method by which the computing device (100) generates a block will be described.

FIG. 2 is a diagram for describing an example of a method by which a computing device generates a block according to several embodiments of the present disclosure.

Referring to FIG. 2, the controller (110) of the computing device (100) may obtain a first transaction from a node in which a transaction included in the blockchain network (200) has occurred (S110). A transaction may be understood as a transaction history of a transaction performed by at least one node included in the blockchain network (200). A transaction may also be understood as a minimum unit of indivisible business processing.

When the first transaction is obtained, the controller (110) may determine whether any one of preset conditions is satisfied (S120).

The preset conditions may include a first condition and a second condition.

The first condition may be a condition that is satisfied when receiving the first transaction causes the number of transactions not recorded in a block to reach a preset number.

For example, the preset number may be 1,000. The controller (110) may determine that the first condition is satisfied when receiving the first transaction causes the number of transactions not recorded in a block to reach 1,000. However, the preset number is not limited thereto.

The second condition may be a condition that is satisfied when an acquisition time of a second transaction acquired earliest among transactions not recorded in a block reaches a preset time.

For example, the preset time may be 2 minutes. The controller (110) may store the first transaction in the storage unit (120). Accordingly, the transactions not recorded in a block may include the first transaction. The controller (110) may determine a second transaction acquired earliest among the transactions not recorded in a block. The controller (110) may determine that the second condition is satisfied when the acquisition time of the second transaction reaches 2 minutes. In other words, the controller (110) may generate a first block for recording the first transaction, the second transaction, and other transactions not recorded in a block.

According to an embodiment, whether the preset conditions are satisfied may be determined according to a predetermined order. Hereinafter, an example of a method by which the controller (110) determines whether the preset conditions are satisfied according to a predetermined order will be described with reference to FIG. 3.

When any one condition is satisfied (S130, Yes), the controller (110) may generate a first block for recording the first transaction (S140). Alternatively, when none of the conditions is satisfied (S130, No), the controller (110) may not generate the first block.

According to the configuration described above, the computing device (100) may generate a block for recording a transaction based on whether any one of preset conditions is satisfied. Accordingly, resources wasted for generating blocks may be saved.

Meanwhile, according to several embodiments of the present disclosure, the controller (110) may determine at least one hash rate for determining a reward according to generation of the first block. Here, the hash rate may refer to computing power input to support the blockchain network (200). The hash rate may affect how much reward can be obtained from mining. However, most current blockchain reward structures are configured such that only a node that generates a block receives a reward, which causes various problems such as competition involving unnecessary energy waste for block generation (POW) and stake-rate competition involving the rich getting richer and the poor getting poorer (POS). To solve these problems, the controller (110) may determine at least one hash rate among a volume hash rate, an additional hash rate, and a time hash rate.

The volume hash rate (V−Hash/s) may be a hash rate related to a quantity staked in a plurality of nodes included in the blockchain network (200). The volume hash rate may be an incentive indicator representing a volume staked in a blockchain node. Staking may be an act of entrusting a certain amount of cryptocurrency held by each node to the network. The volume hash rate of the computing device (100) may be determined by adding a volume staked in the computing device (100) and a staking volume (b−vHash/s) of a node of an affiliated block supporter. The volume hash rate may be determined in such a manner as to have a higher value as the quantity staked in the plurality of nodes included in the blockchain network (200) increases.

The volume hash rate may be determined based on the following equation.

$$MN\_VHash / s = m\_vHash / s + b\_vHash / s \qquad [ Equation 1 ]$$

$${\sum }_{i = 1}^{n} {BS}_{iNode . v} = {BS}_{1 Node . v} + {BS}_{2 Node , v} + {BS}_{3 Node . v} + … {BS}_{nNode . v}$$

Here, MN V_Hash/s may be a volume hash rate of a master node group. The master node group may be a group including a master node (computing device (100)) and a plurality of block supporters (BS). m_vHash may be the volume hash rate of the computing device (100). b_vHash/s may be the volume hash rate of a block supporter.

$${\sum }_{i = 1}^{n} {BS}_{iN ode . v}$$

may be MN V_Hash/s. BS_{1Node.v}, BS_{2Node.v}, BS_{3Node.v}, . . . . B_{SnNode.v} and the like may each be a master node or a block supporter. For example, when BS_{1Node.v} has the largest volume, BS_{1Node.v} may become the master node and the remaining nodes may become block supporters. As another example, when BS_{2Node.v} has the largest volume, BS_{2Node.v} may become the master node and the remaining nodes may become block supporters. As another example,

The additional hash rate (e-Hash/s) may be a hash rate that is satisfied when a quantity staked in a plurality of nodes included in the blockchain network (200) exceeds a preset condition. Maintaining a stable blockchain ecosystem may be partially proportional to the quantity participating in staking. Therefore, for a volume staked in excess of a minimum staking quantity condition, the computing device (100) may provide an additional hash (Excess Hash Rate) as an incentive for activation of the blockchain ecosystem. The additional hash rate may be determined by assigning a weight to volumes staked in excess of the preset condition.

The additional hash rate may be determined based on the following equation.

$$MNe - \frac{Hash}{s} = V - \frac{Hash}{s} + e \% = [ ( \frac{{m}_{vHash}}{s} ) + ( \frac{{b}_{vHash}}{s} ) ] * weight ratio ( e \% ) \qquad [ Equation 2 ]$$

$$[ MvHash / s + \{ {\sum }_{i = 1}^{n} {BS}_{iNode . v} = {BS}_{1 Node . v} + {BS}_{2 Node . v} + {BS}_{3 Node . v} + … {BS}_{nNode . v} \} ] * E \%$$

Here, MN e−Hash/s may be an additional hash rate of a master node group. V−Hash/s may be a volume hash value of each master node group. MvHash/s may be the volume hash rate of the computing device (100).

$${\sum }_{i = 1}^{n} {BS}_{iNode , v}$$

### may be MN V_Hash/s.

The time hash rate may be a hash rate related to a time for which staking has been performed in a plurality of nodes included in the blockchain network (200). Although the quantity staked in blockchain nodes is important, a time function indicating that staking should be maintained in the blockchain nodes for a certain period of time may also be a very important factor for blockchain stabilization. Therefore, the computing device (100) may grant an incentive of a time hash rate (t-Hash/s) as an ecosystem activity for blockchain stabilization with respect to a staking quantity maintained for a period exceeding a predetermined period. The time hash rate may be determined in such a manner as to have a higher value as the time for which staking has been performed in the plurality of nodes included in the blockchain network (200) increases.

The time hash rate may be determined based on the following equation.

$$MNt - Hash / s = ( excess maintained node ) * weight ratio ( t \% )$$

The controller (110) may determine a hash rate for determining a reward by summing the volume hash rate, the additional hash rate, and the time hash rate. Accordingly, problems such as competition involving unnecessary energy waste occurring during a block generation process and stake-rate competition involving the rich getting richer and the poor getting poorer may be solved.

Meanwhile, according to several embodiments of the present disclosure, the computing device (100) may determine whether preset conditions are satisfied according to a predetermined order. Hereinafter, an example of a method by which the computing device (100) according to the present disclosure determines whether the preset conditions are satisfied will be described with reference to FIG. 3.

FIG. 3 is a flowchart for describing an example of a method by which a computing device determines whether preset conditions are satisfied according to several embodiments of the present disclosure.

Referring to FIG. 3, the controller (110) of the computing device (100) may determine whether the first condition is satisfied (S210). When the first condition is satisfied (S220, Yes), the controller (110) may generate the first block (S250).

The first condition may be a condition that is satisfied when receiving the first transaction causes the number of transactions not recorded in a block to reach a preset number.

For example, the preset number may be 1,000. The controller (110) may generate the first block when receiving the first transaction causes the number of transactions not recorded in a block to reach 1,000.

When the first condition is not satisfied, the controller (110) may determine whether the second condition is satisfied (S230). When the second condition is satisfied (S240, Yes), the controller (110) may generate the first block (S250).

In other words, the controller (110) may first determine whether the first condition is satisfied and thereafter determine whether the second condition is satisfied.

Specifically, the first condition may be a condition that is satisfied when the number of transactions not recorded in a block reaches a preset number. The first condition may be a condition related to a size of a block. A block exceeding the preset number presented in the first condition may be generated to have a size that consumes a large amount of time and resources for verification. Accordingly, the controller (110) may determine whether the first condition is satisfied in response to receipt of the first transaction. In contrast, the second condition may be a condition that is satisfied when an acquisition time of a transaction acquired earliest among transactions not recorded in a block reaches a preset time. The second condition may be a condition related to a block generation cycle. A transaction generated from at least one node may be approved as a valid transaction only when a block is generated. If generation of a block is delayed because the first condition is not satisfied, it may be difficult for a user to determine whether a transaction has been correctly completed. Accordingly, when the first condition is not satisfied, the controller (110) may determine whether the second condition is satisfied.

Meanwhile, when the second condition is not satisfied (S240, No), the controller (110) may not generate the first block.

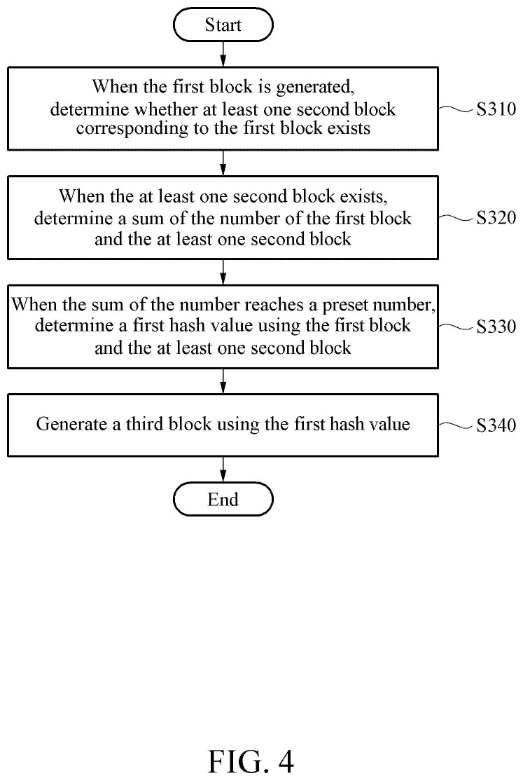

Meanwhile, according to several embodiments of the present disclosure, the computing device (100) may improve enlargement of accumulated blocks on the blockchain network (200). For example, the computing device (100) may improve enlargement of blocks by compressing generated blocks. Hereinafter, an example of a method by which the computing device according to the present disclosure compresses blocks will be described with reference to FIG. 4.

FIG. 4 is a flowchart for describing an example of a method by which a computing device compresses blocks according to several embodiments of the present disclosure.

Referring to FIG. 4, when the first block is generated, the controller (110) of the computing device (100) may determine whether at least one second block corresponding to the first block exists (S310).

Specifically, the first block may be a block generated through step S140. The first block may be a block generated as the first condition or the second condition is satisfied. The at least one second block corresponding to the first block may also be a block generated as the first condition or the second condition is satisfied.

When the at least one second block exists, the controller (110) may determine a sum of the number of the first block and the at least one second block (S320). When the sum of the number reaches a preset number, the controller (110) may determine a first hash value using the first block and the at least one second block (S330).

For example, it may be assumed that the preset number is 1,000. When it is determined that the sum of the number of the first block and the at least one second block is 1,000, the controller (110) may determine the first hash value using the first block and the at least one second block.

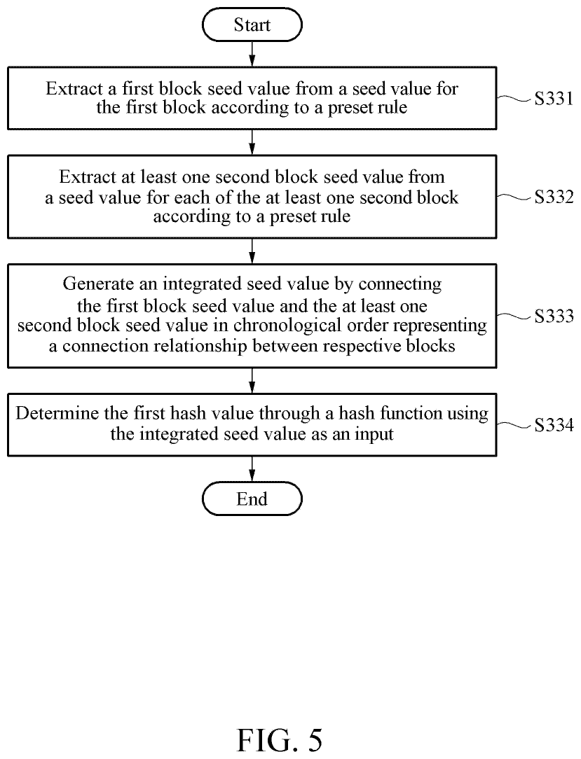

Hashing may be an operation of changing data having an arbitrary length into data having a fixed length. A hash value may be data having a fixed length that is a result of the operation. The controller (110) may determine the first hash value through a hash function. Hereinafter, an example of a method by which the controller (110) determines the first hash value will be described with reference to FIG. 5.

The controller (110) may generate a third block using the first hash value (S340). The third block may be generated to have a size expressed in Kilo units.

Specifically, the first block and the at least one second block may be blocks generated as the first condition or the second condition is satisfied. Accordingly, the first block and the at least one second block may be generated as blocks expressed in minimum units. When the sum of the number of the first block and the at least one second block reaches 1,000 according to the example described above, the controller (110) may generate the third block expressed in Kilo units using the first hash value.

Meanwhile, even when the third block is generated in Kilo units, the size of the third block may not be larger than the size of the first block. Specifically, the third block may be a block generated using the first hash value. The first hash value may be data having a fixed length. Therefore, even when the third block is generated based on the first block and the at least one second block, the data size of the third block is not larger than the data size of the first block and the at least one second block. Accordingly, enlargement of the blockchain network (200) may be prevented even when the number of accumulated transactions increases.

According to an embodiment, the controller (110) may generate the third block based on the following equation.

$$Kilo Hash Block ( Khash block ) = f ( SHA 256 , Kilo Block ) = SHA 256 ( {\sum }_{i = 1}^{1000} {Block}_{i} = {Block}_{1} + {Block}_{2} + … + {Block}_{1 , 000} \qquad [ Equation 4 ]$$

According to an embodiment, when the third block is generated, the controller (110) may determine whether at least one fourth block corresponding to the third block exists. The fourth block may be a block generated in Kilo units. When the at least one fourth block exists, the controller (110) may determine a sum of the number of the third block and the at least one fourth block. When the sum of the number reaches a preset number, the controller (110) may determine a second hash value using the third block and the at least one fourth block. The controller (110) may generate a fifth block expressed in Mega units using the second hash value. In the same manner, the controller (110) may generate a block expressed in Giga units, a block expressed in Tera units, a block expressed in Peta units, or the like.

FIG. 5 is a flowchart for describing an example of a method by which the computing device determines a first hash value according to several embodiments of the present disclosure.

Referring to FIG. 5, the controller (110) of the computing device (100) may extract a first block seed value from a seed value for the first block according to a preset rule (S331).

A seed value or a seed phrase may be a collection of randomly generated words. The controller (110) may extract the first block seed value from a seed value held by the first block according to the preset rule.

According to an embodiment, the controller (110) may extract a word from one region according to the preset rule. For example, the seed value of the first block may be a collection of 12 to 24 words. When it is assumed that the seed value is a collection of 12 words, the collection of 12 words may be generated such that a first word exists in a first region located first, a second word exists in a second region located second, and so on. The controller (110) may determine the first block seed value by extracting the first word existing in the first region according to the preset rule. Alternatively, the controller (110) may determine the first block seed value by extracting the second word existing in the second region according to the preset rule.

The controller (110) may extract at least one second block seed value from a seed value for each of the at least one second block according to the preset rule (S332).

For example, the seed value of the second block may be a collection of 12 to 24 words. When it is assumed that the seed value is a collection of 12 words, the collection of 12 words may be generated such that a first word exists in a first region located first, a second word exists in a second region located second, and so on. The controller (110) may determine the second block seed value by extracting the first word existing in the first region according to the preset rule. Alternatively, the controller (110) may determine the second block seed value by extracting the second word existing in the second region according to the preset rule.

The controller (110) may generate an integrated seed value by connecting the first block seed value and the at least one second block seed value in chronological order representing a connection relationship between respective blocks (S333).

Specifically, it may be assumed that the first block is a block generated after the at least one second block is generated. In this case, the first block may include a block hash value of the at least one second block. Through this, it may be confirmed that the first block is a block generated after the at least one second block, and that the first block is a block associated with the at least one second block. The controller (110) may generate the integrated seed value using chronological information indicating that the first block is generated after the at least one second block.

For example, it may be assumed that the controller (110) determines the first block seed value by extracting the first word existing in the first region of the first block. It may be assumed that the controller (110) determines the second block seed value by extracting the first word existing in the first region of the second block. The controller (110) may generate the integrated seed value such that the second block seed value precedes the first block seed value.

The controller (110) may determine the first hash value through a hash function using the integrated seed value as an input (S334). The hash function is a function that receives an input value of arbitrary length and outputs a value of fixed length. The controller (110) may determine the first hash value from the integrated seed value using the hash function.

According to the configuration described above, the computing device (100) may generate an integrated seed value by connecting seed values in chronological order representing a connection relationship between blocks. Because the first hash value is generated based on the chronological order representing the connection relationship between the respective blocks, when the first hash value is confirmed, the integrity of the connection between pieces of data may be proven. According to an embodiment, the preset rule for extracting the first block seed value from the seed value held by the first block may be shared with other nodes existing in the blockchain network (200). Accordingly, when the computing device (100) and the other nodes confirm the first hash value, the integrity of data may be more strongly confirmed by checking whether the seed value has been extracted from the first region of the first block.

The description of the presented embodiments is provided to enable any person skilled in the art of the present disclosure to use or practice the present disclosure. Various modifications to these embodiments will be apparent to those skilled in the art of the present disclosure, and the general principles defined herein may be applied to other embodiments without departing from the scope of the present disclosure. Thus, the present disclosure should not be limited to the embodiments presented herein, but should be construed in the broadest scope consistent with the principles and novel features presented herein.

What is claimed is:

1. A block generation method performed by a computing device including at least one processor, the block generation method comprising:
obtaining a first transaction from a node in which a transaction included in a blockchain network has occurred;
when the first transaction is obtained, generating a first block for recording the first transaction based on whether any one of preset conditions is satisfied; and
determining at least one hash rate for determining a reward according to generation of the first block,
wherein the preset conditions include:
a first condition that is satisfied when receiving the first transaction causes the number of transactions not recorded in a block to reach a preset number, and
a second condition that is satisfied when an acquisition time of a second transaction acquired earliest among the transactions not recorded in a block reaches a preset time,
wherein the at least one hash rate includes at least one of:
a volume hash rate related to a quantity staked in a plurality of nodes included in the blockchain network;
an additional hash rate that is satisfied when the quantity exceeds a preset condition; and
a time hash rate related to a time for which staking has been performed in the plurality of nodes included in the blockchain network.

2. A block generation method performed by a computing device including at least one processor, the block generation method comprising:
obtaining a first transaction from a node in which a transaction included in a blockchain network has occurred;
when the first transaction is obtained, generating a first block for recording the first transaction based on whether any one of preset conditions is satisfied;
when the first block is generated, determining whether at least one second block corresponding to the first block exists;
when the at least one second block exists, determining a sum of the number of the first block and the at least one second block;
when the sum of the number reaches a preset number, determining a first hash value using the first block and the at least one second block; and
generating a third block using the first hash value,
wherein the preset conditions include:
a first condition that is satisfied when receiving the first transaction causes the number of transactions not recorded in a block to reach a preset number, and
a second condition that is satisfied when an acquisition time of a second transaction acquired earliest among the transactions not recorded in a block reaches a preset time.

3. The block generation method of claim 2,
wherein the step of, when the sum of the number reaches the preset number, determining the first hash value using the first block and the at least one second block comprises:
extracting a first block seed value from a seed value for the first block according to a preset rule;
extracting at least one second block seed value from a seed value for each of the at least one second block according to a preset rule;
generating an integrated seed value by connecting the first block seed value and the at least one second block seed value in chronological order representing a connection relationship between respective blocks; and
determining the first hash value through a hash function using the integrated seed value as an input.

4. The block generation method of claim 1,
wherein the step of, when the first transaction is obtained, generating a first block for recording the first transaction based on whether any one of preset conditions is satisfied comprises:
determining whether the first condition is satisfied;
when the first condition is satisfied, generating the first block;
when the first condition is not satisfied, determining whether the second condition is satisfied; and
when the second condition is satisfied, generating the first block.
